(19) United States
(12) Patent Application Publication
(10) Pub. No.: US 2014/0030459 A1
(43) Pub. Date: Jan. 30, 2014

(54) HYBRID THERMOPLASTIC COMPOSITE COMPONENTS AND PRODUCTS

(71) Applicant: SMARTER PLANET LLC, San Francisco, CA (US)

(72) Inventors: David Mayer de Rothschild, Buckinghamshire (GB); Michael Robert O'Reilly, San Francisco, CA (US); Gregory William Pronko, San Francisco, CA (US); Frank P. Becking, Palo Alto, CA (US)

(73) Assignee: SMARTER PLANET LLC, San Francisco, CA (US)

(21) Appl. No.: 13/951,264

(22) Filed: Jul. 25, 2013

Related U.S. Application Data
(63) Continuation of application No. PCT/US2012/023009, filed on Jan. 27, 2012.
(60) Provisional application No. 61/437,492, filed on Jan. 28, 2011.

(51) Int. Cl. C08L 87/00

(52) U.S. Cl. CPC C08L 87/00
USPC 428/36.92; 525/50

(57) ABSTRACT

Included herein are constructional techniques as well as finished goods produced thereby including thermoplastic composite fabric partially or fully bonded in selected locations and unbonded or less completely bonded in others. These multiple-phase or hybrid goods may comprise structural members such as cabling, shelter components, storage or shipping containers, furniture, clothing, protective gear, water craft, or other constructions.

### CROSS-REFERENCE TO RELATED APPLICATIONS

This application is a continuation of International Application No. PCT/US2012/023009, filed Jan. 27, 2012, which claims priority to U.S. Provisional Application Ser. No. 61/437,492, filed Jan. 28, 2011, both of which are incorporated by reference herein in their entirety for all purposes.

### BACKGROUND

Self-reinforced thermoplastic composites have found utility in a variety of fields. Much of the previous innovation has focused on performance attributes, including the ability to shape, reshape and join the composite pieces. Some attention has been given to the material in terms of its potential for recycling and closed-loop “cradle-to-cradle” product cycles or systems.

The assignee hereof (Smarter Planet, LLC) is in the business of implementing such product solutions as its members successfully demonstrated with the Plastiki project. The Plastiki boat was built using a srPET (self-reinforced polyester) composite frame securing 12,000 two-liter bottles for buoyancy. These elements, together with the boat cabin, furniture, rudder and other structural features we built from srPET. Thus, if ever stripped of its rigging, the Plastiki can be fully recycled. It can be inserted into the PET recycling stream and fully utilized in any number of newly-minted consumer goods.

The building of the Plastiki and its voyage across the Pacific Ocean are well publicized. The vessel embodies a vision of recycled/recyclable product use. Through this vision, the public learned key messages of conservation.

Unexpected, however, was the public's keen interest in the underlying srPET technology upon which the craft was built. Government representatives, academic leaders, corporate chiefs and others voiced immediate interest in high-value structural goods produced for and from this recycled “high-tech” material. That interest represents a need which has not been met by others working in the thermoplastic composites field.

### SUMMARY

None of the inventions or inventive aspects described herein were employed on the Plastiki. Yet, the experience of the project fueled the creativity of the inventors—just as the Plastiki has energized the public—to new construction possibilities with thermoplastic composites. These possibilities are especially beneficial in an ecological sense when implemented with easily recyclable materials. Accordingly, srPET composite material is a focus. The high melt (high tenacity fiber component) and lower melt (matrix material component) portions of the srPET material are chemically compatible such that structures can be ground/chipped-up at the end of their useful life and incorporated directly into the existing PET waste stream that now largely constitutes spent two-liter bottles. However, it is to be understood that the teachings herein are generally applicable to other thermoplastic composite materials such as produced by Comfil, Inc. and/or others. In any case, several such examples are provided in the table below:

| | Reinforcement | Matrix | Weight % |
|---|---|---|---|
| g/m2 | Fibre | Fibre | Reinforcement |
| 750 | Glass | LPET | 57 |
| 750 | Glass | PET | 57 |
| 700 | Glass | PP Black | 60 |
| 1485 | Glass | PP Black | 60 |
| 760 | Glass | PPS | 63 |
| 500 | Carbon | LPET | 54 |
| 390 | Carbon | LPET | 54 |
| 1200 | Carbon | LPET | 54 |
| 710 | HTPET | LPET | 50 |
| 555 | HTPET | LPET | 50 |
| 980 | Aramid | LPET | 48 |

Other materials to form layers of composite material that may variously be utilized in the present inventions are described in any of U.S. Pat. Nos. 3,765,998; 4,414,266; 4238,266; 4,240,857; 5,401,154; 6,828,016; 6,866, 738 and US Publication Nos. 2001/0030017 and 2011/0076441 among others.

As for the innovation(s) presented herein, they include a number of thermoplastic construction “tools” suitable for producing high-value self-reinforced composite good in hybrid form. By “hybrid” what is meant is that they include multiple phases of composite material as further described below. And further that the material may be limited to thermoplastic composite material by design or necessity in producing the types of structures described.

In contrast, U.S. Pat. Nos. 5,418,035; 5,464,493 and 6,162,314 teach stacking and selectively bonding/welding/laminating portions of layers of thermoplastic composite fabric together for handling purposes as an intermediate step of processing. Final processing occurs when the remainder of a given preform is heated under pressure to consolidate/laminate and harden the entire structure. In the latter patent, the welded sections may also be used for part alignment/indexing. Each of these referenced patents contemplate heating the entire structure to flow the matrix material to harden throughout in defining a final structure bonded throughout.

The present inventions are directed to thermoplastic composite products in which the final product includes sections in which matrix material does not flow throughout the structure. The resulting structures include fully-hardened and less-hardened or non-hardened portions of the final product. Stated otherwise, it has been appreciated by the inventors hereof that the fabric (non-bonded) phase and a semi-bonded or “controlled melt” phase of a thermoplastic composite fabric and/or plies thereof each offer significant utility without further processing. Typically, one or both these phases is used in conjunction with a fully bonded phase. A controlled melt phase element included in the product (i.e., a composite material phase generated by the intentional distortion of hybridized thermoplastic fibers in a controlled area by specified combinations of heat pressure and time) may include:
flattening the previously cylindrical matrix fiber shape;
intermittent bonding to a percentage of adjacent fibers;
development of physical relationships to a controlled percentage of adjacent fibers by means of molten matrix bridging with adjacent fibers;
intentional inclusion of void space for purpose of maintaining specific flex/stiffness relationship of the composite without requiring a pre-determined area containing fewer or additional fiber count to achieve the same effect;
creation of a “surface shell” whereas the top, bottom, or both sides of the fiber/matrix profile maintains a higher volume of linked fiber/matrix/fiber bonds with intentionally managed void percentage to achieve desired result;
development of a linked fiber/matrix profile where the percentage of intentional void space is controlled throughout a specified thickness varying from one side to the other;
the intentional inclusion of void space allowing the matrix/fiber bridging effect to isolate movement over a percentage of the higher stiffness fibers length while allowing the un-bridged sections to bend and elongate without opposition;
the intentional inclusion of void space between thermoplastic fiber/matrix bonding sites for the specific purpose of creating a flow path for additional matrix material of a different formulation to be incorporated into this void space to incorporate novel properties (e.g., lower melt adhesives, sealing polymers, elastomeric fillers); and/or
the intentional inclusion of void space between thermoplastic fiber/matrix bonding sites for the specific purpose of creating a flow path specifically to act as an anchoring system for secondary surface bonding processes.
   Of note is the fact that producing the controlled melt material phase (i.e., to produce a partial/semi-consolidated phase of material incorporated in a product) is dependent upon the use of comingled composite material as illustrated. However, products consisting of fully consolidated and completely unconsolidated (i.e., unaltered fabric) material can be produced with other composite fabric/matrix system.

The subject technique may be paired/utilized in connection with known techniques for handling composite material. Examples of such techniques defining the state of the art (e.g., for molding, stamping, heating, cooling, etc.) are included in the referenced patents, each patent incorporated by reference herein in its entirely. The present inventions also include the subject products, kits (for production, distribution, sale or otherwise) in which they are included and methods of manufacture and use. More detailed discussion is presented in connection with the figures below.

### BRIEF DESCRIPTION OF THE FIGURES

The figures provided herein may be diagrammatic and are not necessarily drawn to scale, with some components and features exaggerated for clarity. Each of the figures diagrammatically illustrates aspects of the inventions. Of these:

FIGS. 1A-1D are a series of perspective views illustrating stages of composite tow production and process states;

FIG. 2 is a partial section view of a multi-phase or “hybrid” composite tow of material;

FIGS. 3A and 3B illustrate optional, alternative, processing approaches of hybrid material production;

FIG. 4 is a flowchart illustrating optional manufacturing approaches for yielding final goods;

FIG. 5 illustrates a hybrid shoe product;

FIG. 6 illustrates a hybrid shoe string;

FIG. 7 illustrates a hybrid shin guard/protector;

FIG. 8 illustrates a hybrid cable and eyelet;

FIG. 9 illustrates a hybrid kayak;

FIG. 10 illustrates a hybrid ballistic or blast curtain;

FIG. 11 illustrates a hybrid shelter;

FIG. 12 illustrates a hybrid hinge member with associated hardware;

FIG. 13 illustrates a hybrid object container;

FIG. 14 is a section view of a hybrid solar panel; and

FIG. 15 illustrates a hybrid (unibody) filter or evaporative cooler element.

Variations of the inventions from the examples pictured are contemplated. Accordingly, depiction of aspects and elements of the inventions in the figures are not intended to limit the scope of the inventions. However, the figures themselves and included text incorporates features that may be set forth otherwise in the specification may serve as the basis for claim limitations—as originally presented or as introduced by amendment.

### DETAILED DESCRIPTION

As per above, the present inventions includes constructional techniques as well as finished goods produced thereby. The techniques can be regarded as new “tools” that can be applied broadly across the composites fields, especially within the self-reinforced composite field. As such, various exemplary embodiments are described below. Reference is made to these examples in a non-limiting sense. They are provided to illustrate more broadly applicable aspects of the present inventions. Various changes may be made to the inventions described and equivalents may be substituted without departing from the true spirit and scope of the inventions. In addition, many modifications may be made to adapt a particular situation, material, composition of matter, process, process act(s) or step(s) to the objective(s), spirit or scope of the present inventions. All such modifications are intended to be within the scope of the claims made herein.

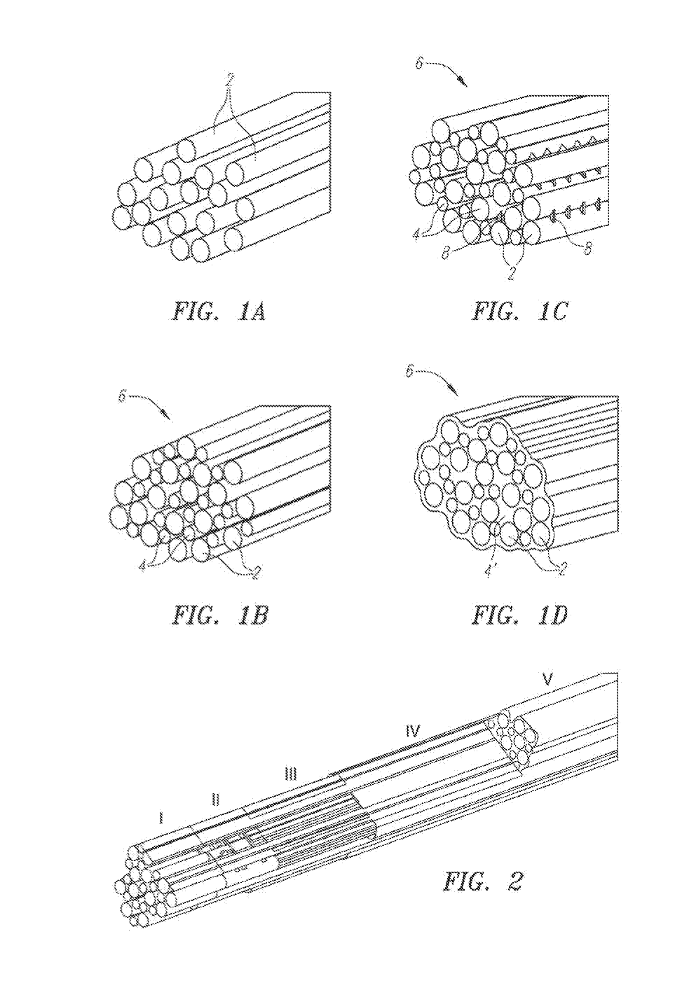

FIGS. 1A-1D are a series of perspective views illustrating stages of composite tow production and process states. FIG. 1A shows a bundle of reinforcement fibers 2 (e.g., HTPET, Carbon, Kevlar, Gals, Natural Fiber, etc.) alone. These high tensile strength fibers are primarily responsible for the stiffness load bearing, and limit elongation of the composite material. In FIG. 1B these are shown unprocessed, but comingled with matrix material fibers 4 comprising thermoplastic material selected to melt when heated in combined fiber or tow 6. These are blended together with the high tensile fibers to ensure multiple matrix fibers are adjacent every high tensile fiber. Upon partial heating as shown in FIG. 1C, the matrix material begins to met, flow and adhere to the high-tenacity fibers. Precise control of heat and pressure enables the matrix polymer fibers 4 to melt and begin to form bonds on bridges 8 to adjacent fibers in all directions. The percentage or remaining void space is responsible for unique attribute that are captured when they appear consistent over a cross section of the resulting composite fabric woven, braided, knit, etc. from the tows. The affected area can be from the outside inward, from one side toward the other or evenly through the composite material. This state is enabled by virtue of the blending of matrix fibers through the tow. As controlled pressure is applied through the heating process, the previously cylindrical shape of the matrix fiber/tow can be distorted into a flatter elliptical column which in itself provides unique material performance. In FIG. 1D, the matrix fibers have completely melted into a matrix mass 4′ and encapsulate the high tensile reinforcement fibers 2 with little or no void space. Such material is said to be fully consolidated. Whereas the state in FIG. 1C represents semi- or partially-consolidated material. Control of the degree, location, direction/orientation of the melt or consolidation of the matrix fibers allows for tailoring properties including, but not limited to flex, permeability, hardness, stiffness, toughness and impact resistance. Such control is possible over small areas and/or large areas of the same part while using the same fibers.

FIG. 2 is a partial section view of a multi-phase or “hybrid” composite tow as may be incorporated in fabric, braid, etc. Five phase sections are described. Phase I comprises dry fiber comingled together. These can be woven/braided, etc. into fabric using conventional methods. No heat/temperature above the melting point (or pressure) is applied to this phase. Thus, the material remains soft and pliable. Phase II comprises matrix fibers brought to a low melt stage through the cross section. The phase is characterized by controlled melt with about 80% to about 98% void space left throughout the cross section. Thus, the material becomes semi-permeable, begins to achieve some shape memory and is highly bendable, but still may be sewn, tied and otherwise processed like unaltered fabric. Phase III comprises matrix fibers that have been distorted to begin partial encapsulation of high tenacity fibers throughout cross section. When the process has reached this state a wide variety of desirable attributes have been captured as suitable for a living hinge that will simply rotate/pivot vs. displace vertically “droop”. Thus, the material achieves a semi rigid definitive shape memory, and adhesive properties now available for bonding to adjacent parts. The matrix has stabilized enough to effectively maintain desirable fiber alignment thereby offering good potential for die cutting or shaping. This phase is characterized by controlled melt with about 50% to about 80% void space left throughout cross section. Phase IV comprises matrix fibers that have now become an intentional web of bridges with a controlled void space content which is bordering a semi solid composite. Thus the material in this phase allows molding in features with excess matrix providing bond, or shaping by tooling. Cosmetically, the fiber appearance is transforming to a plastic or resin look. This phase is characterized by controlled melt with about 15% to about 40% void space left throughout cross section. Phase V comprises matrix fibers that have liquefied and behave similar to most conventional thermoplastic composites used in the industry. Thus, the material properties of the composite are similar for what would be expected from the blend of thermoplastic matrix with specific reinforcement fiber properties once consolidated by conventional techniques. This phase is characterized by controlled melt with about 0% to about 15% void space.

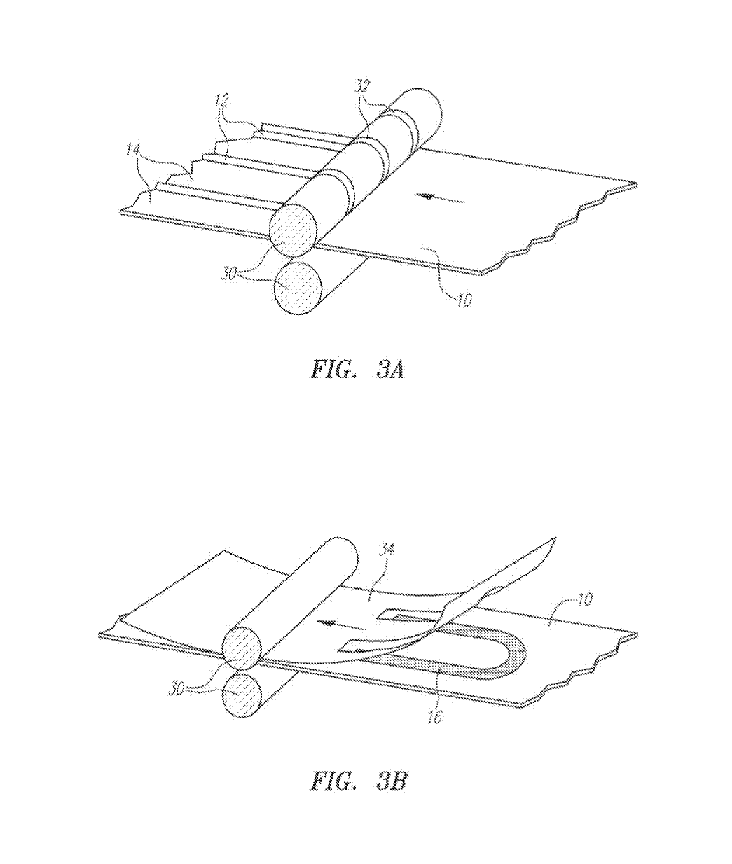

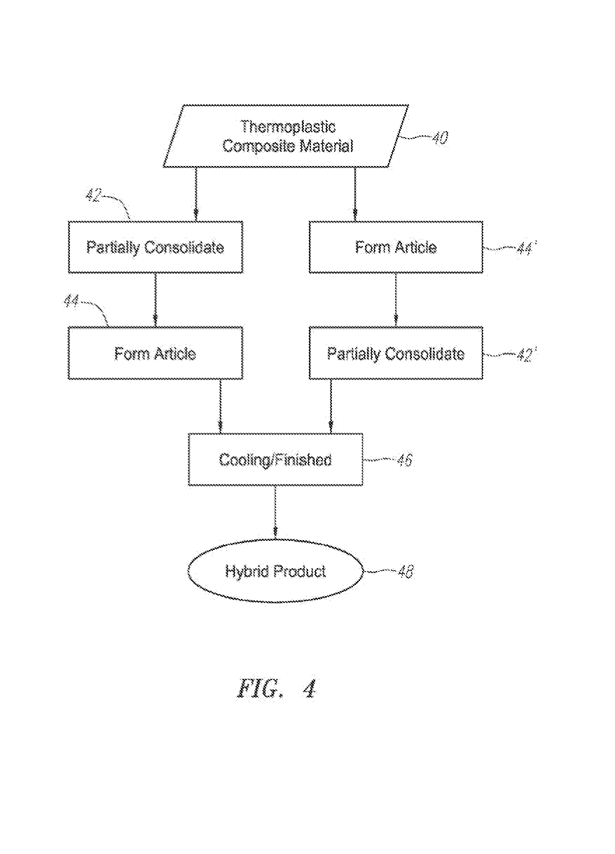

The manner of producing the phases of material for the finished hybrid goods implemented in the examples derive from a number of methods and can be characterized variously. In one approach illustrated in FIG. 3A, hot-press rollers 30 (applying heat and pressure there between) are provided in which certain sections (in at least one of the rollers nips) are relieved with grooves or channels 32 to avoid contact with the underlying coming led thermoplastic composite material 10 and enable partial processing of the material in sections 12. Without heat and pressure applied thereto, the sections may remain as unaltered thermoplastic composite fabric or partially consolidated fabric (i.e., typically as between Phase I and Phase III as discussed above), whereas remainder portions 14 may be nearly of fully consolidated (i.e., typically as between phase Phase IV and Phase V as discussed above). Channels or shapes defined in the roller nip or alternatively press plates/platens if used instead may receive active or passive cooling (e.g., water lines may pass therethough). Another approach may utilize spring loaded sections that exert less force than adjacent sections in a heated roller or press configuration.

As illustrated in FIG. 3B, yet another approach employs a masking element 34 (e.g. PTFE sheet, peel ply, etc.) to shield heat transfer to selected sections of material 10 and deliver full transfer to a shaped section where higher consolidation (e.g., Phase III to Phase IV) is desired. Still further, selected use of vacuum may be employed to remove air in sections adjacent controlled melt phase material. Control of the material selection within a layup offer another option. Namely, one may employ the use of higher melt films or fibers of same polymers to create areas that do not consolidate and leave unbonded material. Such an approach can be employed to create pockets that may later be expanded (e.g., by introducing air pressure) in reforming a perform, that may be used to yield an unbonded core such as in the solar panel configuration above, or be employed otherwise.

Turning now to FIG. 4, alternative fabrication processes are described. At 40, thermoplastic composite material is obtained and prepared. In the “a” flow path the material is processed at 42 per FIG. 3A or 3B above (or otherwise) to provide some sections that are at least partially consolidated. Some may be fully consolidated. With the material so-prepared, then the final article of manufacture can be formed at 44. The forming contemplate stitching together pieces of material, possibly further heating and selective material consolidation. In the latter event, a final process block 46 before yielding a final product at 48 may include a cooling step. In any case, the desired finishing may include trimming or adding ancillary components such as soles to a shoe, laces, etc. In an alternative process path “β”, the article is first put together in fabric form at 44′ and elements or portions at least partially consolidated at 42′.

One aspect of the inventions contemplates a 3-phase finished good. As illustrated in FIG. 5, one example is a shoe 50. In the shoe, the footbed 52 is provided by a fully bonded/consolidated section. Support structure sections 54 are semi-bonded, and fully flexible sections 56 are un-bonded where a high amount of movement, flex, and breath ability are desired. Fully bonded/welded/laminated lace grommets/eyelets 58 may also be included.

Regarding performance design, stored energy components may be incorporated into the actual material by controlling the void-space over a specific length of a feature and developing that same feature to utilize a geometric advantage. The material can transform from 0% void space to a high percentage of void-space (becoming flexible) and providing an elongation component similar to a spring. In the support sections, the same material is used but having been brought to a controlled melt phase whereas 15% to 75% void space resulting in stiff or progressive reinforcing sections for support structure, and strategic stiffening. Breathable sections (e.g., midfoot at 58 and in the toe) are offered by the controlled melt phase between 80% to 98% void space or fully fabric thermoplastic commingled material.

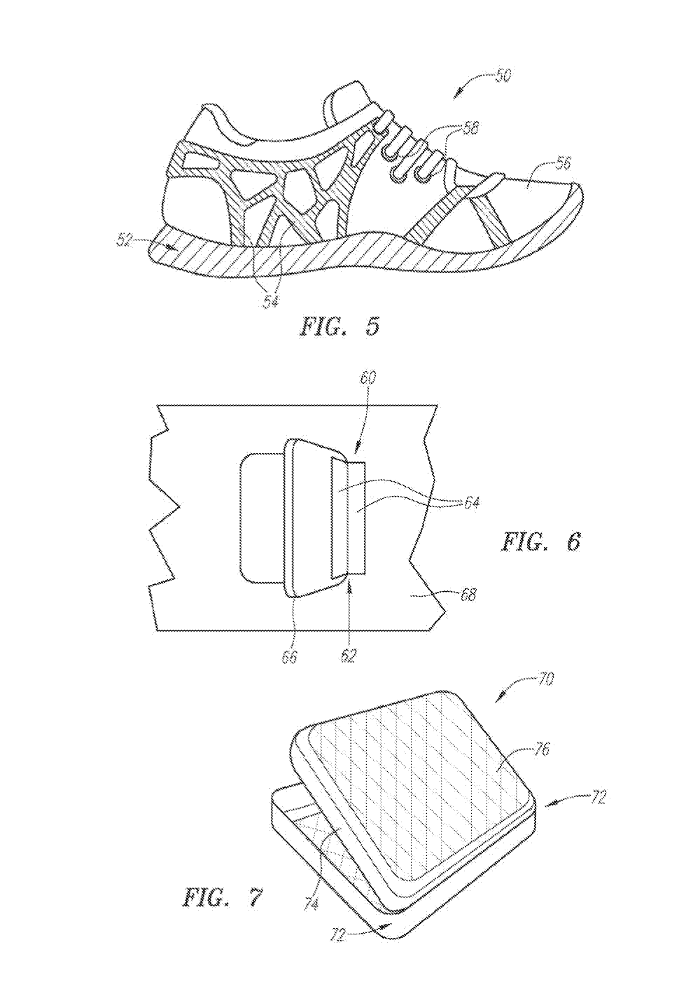

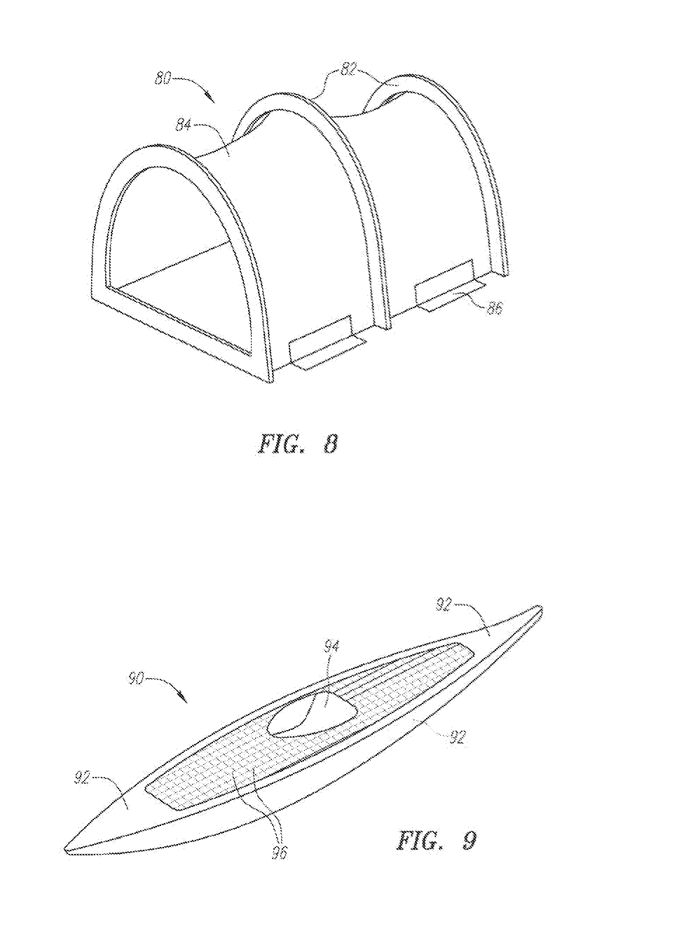

Another aspect contemplates a 2-phase finished good including fully bonded and semi-bonded material. As illustrated in FIG. 6, a successful living hinge 60 (one that maintains vertical stability without “drooping”) comprises the semi-bonded/controlled melt phase material portion 62 as noted above, while door and/or adjacent connector 64 are fully-bonded (and optimally bonded or mechanically attached to a door 66 and door frame 68). Optionally, the connector tab section on the door or support panel/frame may have thickness milled away. This provides an advantage as the nature of long fiber reinforcement composites is to dissipate local stresses over great areas as transversed by high numbers of fibers. Previous hinges and hinge attachment techniques are notorious for point loading of high stress forces. The fiber may be oriented, for example, at 0/90° or +/−22° with tenacity fibers added to provide a long acting living hinge where the fibers enable enhanced fatigue resistance while simultaneously preventing droop effect which would likely occur if fibers were not included.

A living hinge structure can also be successfully implemented in containers (such as suitcases and/or cargo containers). An exemplary container 60 that may be formed from a single piece of thermoplastic composite material with a living hinge section 62 (full fabric or semi/partially consolidated) is illustrated in FIG. 13. Further, a durable outer frame 64 is developed with low (e.g., 0 to 40%) void-space acting as a support frame. In addition faces 66 may be thermo-formed to aesthetic patterns (a diamond pattern is illustrated) or for mechanical purposes like traction or scratch resistance. A container may be sized for small object and further include a living-hinge latching mechanism (obscured from view) or larger as a chest or other item of furniture.

Yet another application is in durable temporary structures including shelters 80 as illustrated in FIG. 8 and hard-bottomed boats/tenders/canoes or a kayak 90 as illustrated in FIG. 9.

For shelter 80, supporting structures for (optionally) monopolymer textile based shelters can be obtained by achieving higher density melt phases to provide a wide variety of stiffness and shape control. Such support segments 82 may be developed by heating/compressing certain parts of the same fabric used for the rest of the shelter. More flexible, foldable, or pre-pleated sections 84 are obtained with controlled melt phase with 15-75% void-space maintained. Integrated stiff sections, tabs 86 for attachment to surfaces, may also contain soft sections or holes for spikes or hardware.

For water craft 90, stiff and durable surfaces are developed with low % void space for the rigid structural supporting sections 92 of boats, kayaks, canoes, tenders, etc. Softer portions 94 are left flexible to provide for seating, storage compartments, tie downs and foot support. Ribbed sections 96 are formed for flexing and spring loaded active portions of the craft.

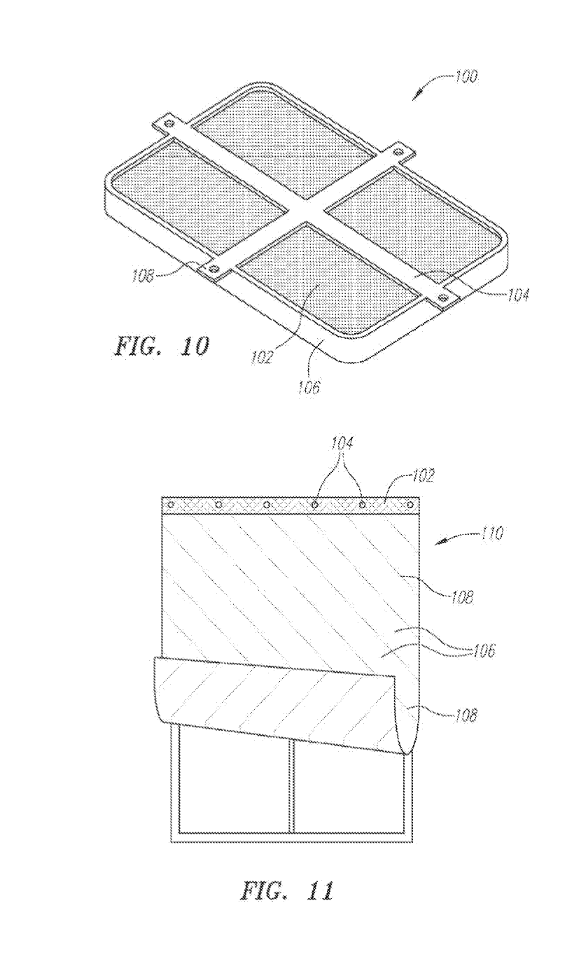

Another aspect contemplates a 2-phase finished good including unbonded (i.e., fabric) and fully or semi-bonded material. As illustrated in FIG. 10, an exemplary (optionally, mono-polymer) filter or evaporative cooling structure 100 employs a fabric center section 102 with heat/pressure molding to maintain high void % or combined with mechanical perforating. The same material is also further compressed to provide an integral support system with ribs 104 to maintain filter shape with a stabilized edge frame 106 preferably from fully bonded/consolidated material for support and/or for attachment points 108 for auxiliary equipment interface.

Blast or ballistic “curtain” or panels offer another example. As shown in FIG. 11, curtain 110 includes unbonded or semi-bonded attachment strip 102 for hammering nails therethrough or a more fully consolidated bar with pre-defined through holes 104 for hanging. In addition, fully bonded and hardened panel sections 106 are included. These are made in one piece (laminated from multiple layers) with hinges 108 for folding/rolling the structure for efficient storage and rapid deployment.

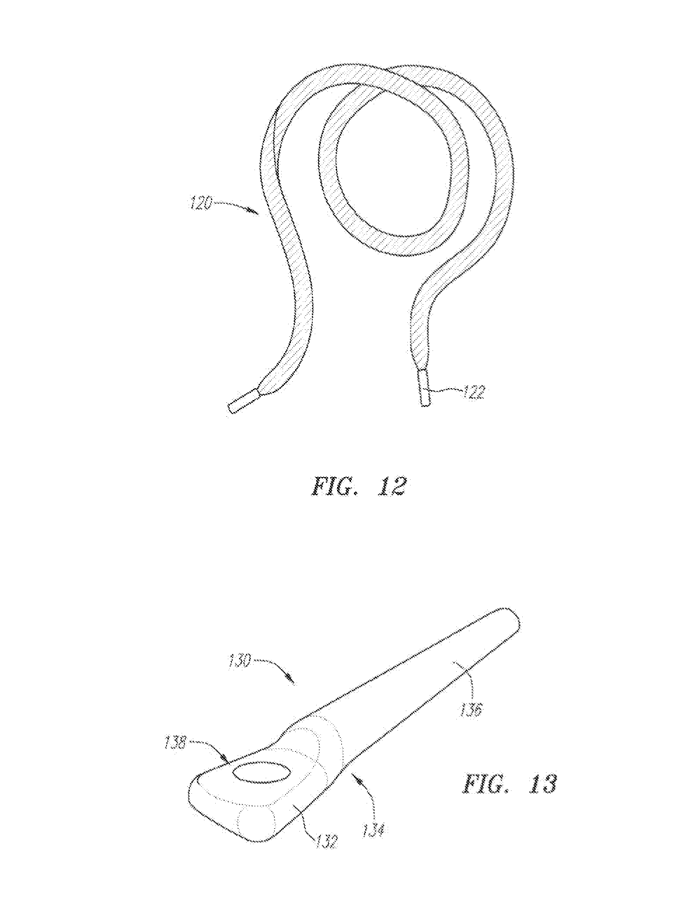

Another class of such goods includes cables and laces. Uniquely strong and easily managed thermoplastic reinforced structures can be produced (utilizing the high-tenacity fibers for strength along the length of the elongate member) in which integrated terminal features are formed. For a shoe lace 120, as shown in FIG. 12, the terminal ends may be simple cylindrical features 122. An elongate body 124 is formed by material is left as a high strength woven fabric. For a cable 130 (be it configured round, braided, twisted, flat, or otherwise irrespective of how illustrated in FIG. 13) high-strength eyelets or bosses 132 can be produced with more/fully bonded end sections. Transitional stiffness zones 134 can be developed through controlled heat/pressure molding to develop and increase of void spaces over a specific distance to eliminate stress spots or gradually gain flexibility along the elongate body 136 maintained as component fiber weave. The main body of the cable maintains the same long fibers that as are encapsulated in the hardened ends for through-hole 138 or other attachment feature(s).

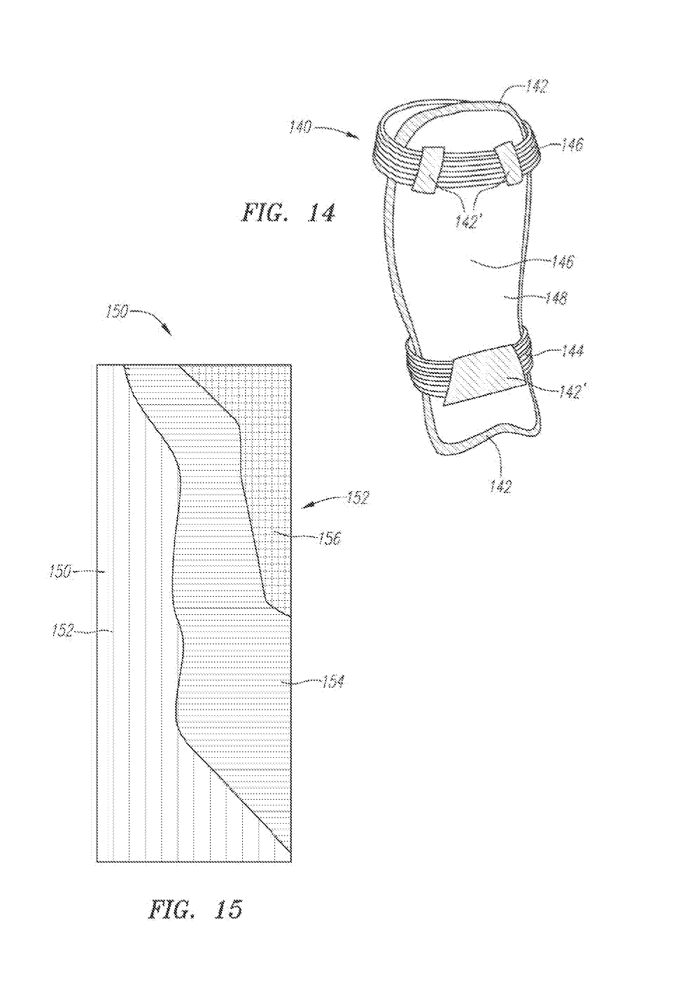

As illustrated in FIG. 14, protective gear or padding 140 (e.g., soccer shin guards, football pads, hockey or lacrosse pads—for shoulder, elbow, etc.) can incorporate either two, three or all of the characterized phases of material. The most flexible sections will be unbonded. Soft sections 142 are integrated for comfort and to provide secure fit. Soft sections 142′ may also be integrated to accept straps 146 or supports or provide tabs of material more suitable for sewing or stitching. The most impact-resistant sections 148 are fully bonded and hardened. The high tenacity fibers therein may be layered in specific directions to provide vertical stiffness while allowing for horizontal flexibility to provide maximum comfort and protection. Mid-range property material 146 (i.e., semi-bonded or controlled melt phase material) can provide transition between the two The high tenacity fibers therein may be layered in specific directions to provide vertical stiffness while allowing for horizontal flexibility to provide maximum comfort and protection. Certainly, the mid-range material may be omitted. Also, when no flex points are desired (but impact transition zones are) the padding/guard may only include fully-bonded and semi or partially bonded material. Moreover, such structures may (and will typically) include additional padding or batting material (e.g., foam rubber) material. In which case, the thermoplastic composite material may serve as a mounting substrate as well as flexible or tuned-flexibility webbing for connecting various features.

It should also be understood that the structures may be produced in one piece. However they may be constructed as assemblies. The presence of unbonded fabric for stitching or otherwise connecting the pieces (e.g., by stitching) may be advantageously used in this regard.

Industrial implementations are also contemplated. One example is a solar panel 150 as illustrated in FIG. 15. It includes fully bonded/hardened “skin” or facing portions 152 (possibly also internal ribs 154) and an unbonded/fabric internal matrix 156. An internal structure is produced by the intentional inclusion of void-space created as the self-reinforced fabric is processed. This specialized core allows for the liquid to flow through the panel while efficiently extracting heat transferred through the fibers. Simply put, water can pass or percolate through the unbonded material. Such a structure offers potential for high-pressure (and thus higher temperature) operation for dramatic efficiency gains. Production processing is also simplified. Outside layers of the panel are formed from stiff plies of completely consolidated material forming an airtight durable skin which can handle the effects of exposure to the elements. Frame and mounting sections are produced from the same material with higher stiffness. The material can be dyed black, eliminating the need for coatings or paint to increase the thermal efficiency. A barrier layer 156 may be incorporated to allow liquid to loop from the top flow layer down around one end and return along the bottom layer to maximize thermal transfer and allow for single sided attachment.

For active sections in any reference structure (e.g., a hinge point or region) or as otherwise constructed with the teachings herein, the design can factor-in different long-fiber reinforcement shapes (e.g., flattened fibers as noted above). Other options include such features as described elsewhere in applicant's commonly-owned patents. Likewise, the concepts discussed here may be applied to those detailed therein as well.

Variations

It is contemplated that any optional feature of the inventive variations described may be set forth and claimed independently, or in combination with any one or more of the features described herein. Reference to a singular item, includes the possibility that there is a plurality of the same items present. More specifically, as used herein and in the appended claims, the singular forms “a,” “an,” “said,” and “the” include plural referents unless specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity.

The breadth of the present inventions is not to be limited to the examples provided and/or the subject specification, but rather only by the scope of the claim language. Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section or subsection of this specification (e.g., the Summary, Detailed Description, Abstract, Field of the Invention, etc.) be accorded special significance in describing the inventions relative to another or the claims. Any of the teachings presented in one section, may be applied to and/or incorporated in another. The same holds true for the teaching of any of the related applications with respect to any section of the present disclosure. The related applications are:
Low Weight Reinforced Thermoplastic Composite Goods (US provisional application);
Reconfigured Thermoplastic Composite Constructs (US provisional application);
Topo-Slice Thermoplastic Composite Components and Products (PCT application);
Panel-Derived Thermoplastic Composite Components and Products (PCT application);
and Thermoplastic Structures Designed for Welded Assembly (PCT application),
   each to the assignee hereof and filed on even date herewith. Moreover, each and every one of these applications is incorporated by reference herein in its entirety for any and all purposes, as are all of the other references cited herein. Should any US published patent application or US patent claim priority to and include the teachings of one or more of the aforementioned US provisional applications, then that US published patent application and that US patent is likewise incorporated by reference herein to the extent it conveys those same teachings. The assignee reserves the right to amend this disclosure to recite those publications or patents by name. Although the foregoing inventions have been described in detail for purposes of clarity of understanding, it is contemplated that certain modifications may be practiced within the scope of the claims to be made.

1. A hybrid thermoplastic composite product made by a method of manufacture comprising:
consolidating a piece of thermoplastic composite material to at least two distinct phases of consolidation;
forming an article with the piece of thermoplastic composite material; and
finishing the article as a final product, leaving the different phases of consolidation.

2. The product of claim 1, wherein the thermoplastic composite material is consolidated to three different phases.

3. The product of claim 1, wherein the distinct phases are selected from:
a) between about 0% and about 15% of consolidation;
b) between about 15% and about 40% of consolidation;
c) between about 50% and about 80% of consolidation;
d) between about 80% and 98% of consolidation; and
e) between 98% and 100% consolidation.

4. The product of claim 1, wherein the consolidation in one portion is as little as about 98% void space over a cross-section.

5. The product of claim 4, wherein the consolidation is as little as about 80% void space.

6. The product of claim 5, wherein the consolidation is as little as about 50% void space.

7. The product of claim 6, wherein the consolidation is as little as about 40% void space.

8. The product of claim 7, wherein the consolidation is as little as about 15% void space.

9. The product of claim 8, wherein the consolidation is as little as about 0% void space.

10. The product of claim 1, wherein the consolidating occurs before the forming.

11. The product of claim 1, wherein the forming occurs before the consolidating.

12. The product of claim 1, wherein the finished article comprises unconsolidated and semi-consolidated thermoplastic composite material.

13. The product of claim 1, wherein the finished article comprises unconsolidated and fully-consolidated thermoplastic composite material.

14. The product of claim 1, wherein the finished article comprises semi-consolidated and fully-consolidated thermoplastic composite material.

15. The product of claim 1, wherein the finished article comprises unconsolidated, semi-consolidated and fully-consolidated thermoplastic composite material.

16. The product of claim 1, in the form of a shoe, container, shelter, or curtain.

17. The product of claim 1, in the form of a water craft.

18. The product of claim 1, in the form of an elongate flexible member selected from a cable and a shoe lace.

19. The product of claim 1, in the form of sports protective gear.

20. The product of claim 1, in the form of fluid handling apparatus selected from a filter, heat exchanger and solar panel.
